(19) United States
(12) Patent Application Publication
(10) Pub. No.: US 2015/0227592 A1
(43) Pub. Date: Aug. 13, 2015

(54) Mining Questions Related To An Electronic Text Document

(71) Applicant: HEWLETT-PACKARD DEVELOPMENT COMPANY, L.P., Houston, TX (US)

(72) Inventors: Vidhya Govindaraju, Bangalore (IN); Krishnan Ramanathan, Bangalore (IN); Yogesh Sankarasubramaniam, Bangalore (IN)

(21) Appl. No.: 14/426,367

(22) PCT Filed: Sep. 18, 2012
(86) PCT No.: PCT/IN2012/000625

§ 371 Date: Mar. 5, 2015

(51) Int. Cl. G06F 17/30

(52) U.S. Cl. CPC G06F 17/30539; G06F 17/30867; G06F 17/30648; G06F 17/3053

(57) ABSTRACT

Provided is a method of mining questions related to an electronic text document. Keyphrases are extracted from an input electronic text document, and an online question and answer repository is queried based on the keyphrases. Questions related to the keyphrases are retrieved from the online question and answer repository, and displayed.

### BACKGROUND

The World Wide Web (or web) has become an important medium for source of information. A significant portion of this digital knowledge relates to educational or learning content. For example, there's a large number of technical reports, e-books, white papers, monographs, research papers, journals, etc. available on the web, which a user can read online or download for later consumption. In addition, there are many publishers who upload electronic versions of their books and other learning material online as additional support material for their customers, such as students.

### BRIEF DESCRIPTION OF THE DRAWINGS

For a better understanding of the solution, embodiments will now be described, purely by way of example, with reference to the accompanying drawings, in which:

FIG. 1 shows a flow chart of a method of mining questions related to an electronic text document, according to an example.

FIG. 2 shows a graphical user interface that may be presented to a user, according to an example.

FIG. 3 shows a block diagram of a computer system, according to an example.

### DETAILED DESCRIPTION OF THE INVENTION

The World Wide Web hosts a large amount of content, which could be used by people to obtain information or gain knowledge. For example, there are e-books, research papers, journals, technical reports, etc. available on the web that can be read by users to increase their learning on a subject matter. Apart from the “free” resources online, there are proprietary sources of content as well. For example, there are databases containing scientific reports, technical journals, specialized subject matter book that are provided by publishers on payment of a fee. In summary, there's a large amount of educational content available online.

One of the issues with consumption of learning material online is the lack of a proper mechanism for a user to test his/her learning. For example, let's consider a scenario where a user reads an online article on “Electromagnetic radiation”. After the user has read the article, he/she may want to test his/her understanding through a relevant question-and-answer (Q&A) session. Presently, there's no mechanism which allows a user to check his understanding unless the user performs an additional search for finding relevant question and answers on the subject matter, which is a laborious and impractical task. The above analogy is applicable to many other scenarios, for instance, after a user has read a Wikipedia page, an online book, an analyst's report, or any other published material for that matter. In all these cases, there's no convenient mechanism for a user to test his/her knowledge after a learning session.

Embodiments of the present solution provide methods and systems for mining questions related to an electronic text document. Examples of the present solution enable a user to test his understanding after a learning session, for example after reading an article, book, scientific paper etc., by sourcing questions from a question-and-answer (Q&A) repository.

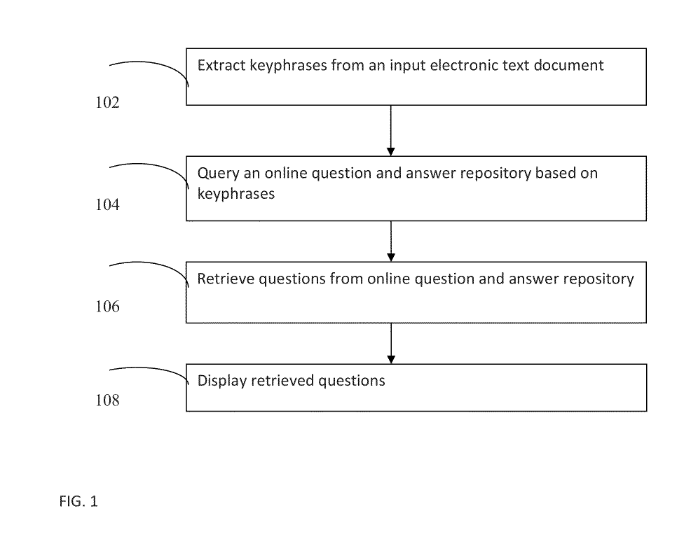

FIG. 1 shows a flow chart of a method of mining questions related to an electronic text document, according to an example.

At block 102, a keyphrase (or key topic) is/are extracted from an input electronic text document. An input text document could be an article, a book, technical reports, e-books, white papers, monographs, research papers, journals, and the like. An input text document could even be a segment from any of the aforesaid document. For example, it could be a chapter from a text book. Also, an input electronic text document may include other media such as an image, an audio, a video, etc.

Keyphrase extraction is used to extract most frequent words which are significant with respect to the applications. In keyphrase extraction a small collection of important words are extracted from a given (possibly large) piece of text. There exist several approaches and tools for automatic keyphrase extraction, which typically rely on extracting high-frequency terms (n-grams) and scoring them using TF-IDF weights. Another popular approach is to use a part-of-speech tagger to identify the leading noun phrases. Some of the known keyphrase extraction tools include KEA, Stanford topic modelling tool, wikiFier, etc.

However, the high-frequency terms or noun phrases may not always the keyphrases. For example, a document with many images has a high frequency of the term ‘Figure’, which is not a keyword for that document. Moreover, words co-occurring with high-frequency words may describe the document better than the high-frequency words themselves. Also, the document and section titles have a greater probability of being keywords. In the present approach, the co-occurrence property is leveraged along with frequency and position of words to find the key terms in the document. A pseudocode of an example approach for extracting keywords is presented below.

```
Input: Document D
Output: Weighted Keyphrases for D
  Compute the frequency f(wᵢ) for each word wᵢ in D, excluding stop words
  Compute the importance g(wᵢ) for each word wᵢ in D. The words that
  appear in the docu: title get an importance score of 5, the words that
  appear in section titles get an importance of 3, and all others are
  weighted as 1.
  Calculate the weight of wᵢ as Weight(wᵢ) = f(wᵢ)g(wᵢ)
  Find the word association weight of word i with word j as follows:
      $Association Weight ( {w}_{i} \vert {w}_{j} ) = {\sum }_{{S}_{ij}} f ( {w}_{i} \vert {S}_{ij} ) g ( {w}_{i} )$
where Sᵢⱼ = {sentence s ∈ D: wᵢ ∈ s and wⱼ ∈ s},
and f(wᵢ|Sᵢⱼ) is the frequency of the word i in sentence Sᵢⱼ
Form a graph G with the top 20% highest weighted words as vertices
for wᵢ ∉ G do
  for wⱼ ∈ G do
      Candidate Node Weight (wᵢ)+ = Association Weight (wᵢ|wⱼ)
  end for
end for
Add words corresponding to top 20% highest Candidate Node Weight. to G
Two words wᵢ and wⱼ in G have a directed edge if the Association Weight
(wᵢ|wⱼ) ≠ 0
For each wᵢ ∈ G, find the neighboring nodes Neighbors(wᵢ)
for wᵢ ∈ G do
  for Neighboring Node wⱼ ∈ Neighbors(wᵢ) do
      Node Weight (wᵢ)+ = Association Weight (wᵢ|wⱼ)
  end for
end for
Select N words with highest Node Weight as keywords.
Find all 2-gram and 3-gram words in D that do not contain a stop word
Weight of a phrase Pᵢ is given by:
    $Phrase Weight ( {P}_{i} ) = \frac{f ( {P}_{i} ) \vert \{ w \text{:} w ∈ {P}_{i} and w ∈ keywords \vert}{( {\sum }_{w ∈ {P}_{i}} f ( w ) ) - f ( {P}_{i} ) \vert {P}_{i} \vert + 1}$
Where f(Pᵢ) is the frequency of Pᵢ in D.
Select phrases with highest Phrase Weight as keyphrases.
```

In an implementation, keyphrases obtained through a keyphrase extraction method may be enhanced using a keyphrase enhancer, the pseudocode of which is given below.

```
Input: List of Keyphrases KP from document D. List of words in D and their
weights Weight (wᵢ),
Minimum Coherence i
Output: Enhanced list of Keyphrases EKP
1. Find a list of terms to add for each query. Weight of a term wᵢ, given the
  keyphrase KPⱼ is computed as follows.
      $W ( {w}_{i} \vert {KP}_{j} ) = Weight ( {w}_{i} ) * {\sum }_{s ∈ sentences} {e}^{- 0.1 ⋆ dist ( i , j \vert s )}$
  where dist(i,j|s) is the number of words between the KPⱼ and wᵢ
2. Set Coherence = 0
3. while Coherence ≦ t do
4.  Map keyphrases to Wikipedia Concepts [WC(KPᵢ)] as in [ ]
5.  Coherence of a keyphrase C(KPᵢ) is computed as follows:
        $C ( {KP}_{i} ) = {\sum }_{{KP}_{j} ∈ Keyphrases , i \neq j} JS ( {KP}_{i} , {KP}_{j} )$
    $where JS ( {KP}_{i} , {KP}_{j} ) = \frac{WC ( {KP}_{i} ) ⊓ WC ( {KP}_{j} )}{WC ( {KP}_{i} ) ⊔ WC ( {KP}_{j} )}$
6.  Coherence of the keyphrase set, Coherence = min C(KPᵢ)
7.  Find the candidate keyphrase for enhancement.
      ${Candidate}_{KP} = arg {min}_{{KP}_{i} ∈ keyphrases} C ( {KP}_{i} )$
8.  Append the keyphrase, Candidate_{KP}, with the word wᵢ as follows
      ${Candidate}_{KP} = arg {min}_{{w}_{i} ∈ words} W ( {w}_{i} \vert {KP}_{j} )$
9. The keyphrases are appended with the right terms and now form the
  enhanced key phrases, EKP
```

In an implementation, if the input electronic text document comprises of multiple pages, the extracted keyphrases are mapped to pages based on the frequency of a keyphrase in a page and the frequency of the keyphrase in all input pages.

At block 104, extracted keyphrases are used to query an online question and answer (Q&A) source (repository). An example of an online question and answer repository includes Yahoo! Answers.

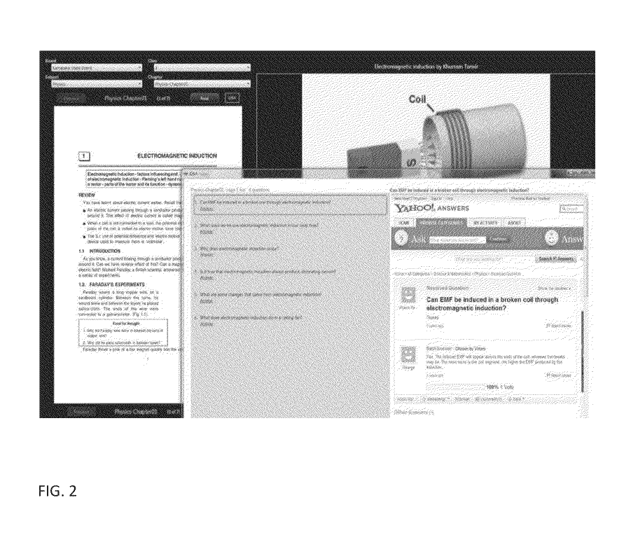

At block 106, questions related to (or based on) extracted keyphrases are obtained from the online question and answer source. An illustration of a graphical user interface for question generation based on an input document is provided in FIG. 2. In the subject illustration, a key phrase “electromagnetic induction” is extracted from an input text document. The aforesaid keyphrase is used to query an online Q&A source, such as Yahoo! Answers, for instance. Some of the questions retrieved in response to the query include: (1) What ways do we use electromagnetic induction in our daily lives? (2) Is it true that electromagnetic induction always produce alternating current? (3) What are some changes that come from electromagnetic induction? etc.

There's a possibility that retrieved questions may include some undesirable or irrelevant questions. In an implementation, such questions are removed from the retrieved questions, based on a criterion, to generate more relevant questions. Said differently, questions may be filtered to generate a filtered set of questions (final questions) which are more pertinent to the key phrases extracted from an input text. For example, grammar of the retrieved questions could be a criterion. Questions with incorrect grammar may be removed by using the parse tags that may be obtained by parsing the questions. In an instance, Stanford Parser may be used to identify grammatically incorrect questions.

In another implementation, a subset of retrieved questions is selected based on criterion such as relevance, diversification, redundancy, novelty, etc. The criterion may be user defined or system defined.

At block 108, originally retrieved questions (or filtered questions, as the case may be) are displayed on a display unit. In an implementation, the retrieved questions (or filtered questions) displayed to a user are dynamically changed each time the user accesses the input electronic text document. For example, if a user is referring to an online textbook, then each time he/she accesses the textbook; he/she would be shown a new set of questions.

In an implementation, a user profile may be created for a user, for example, based on his/her past reading habits which could be inferred from past content accessed by a user. The user profile is used to dynamically change set of originally retrieved questions presented to a user. Questions may be filtered (for instance, ranked) based on a user's profile before they are presented.

In another implementation, a user's response to originally retrieved questions is evaluated and a new set of questions is presented to a user based on the evaluation results. For example, if a user correctly answers most of the originally retrieved questions, a new (and may be more demanding) set of questions may be presented to the user. In an example, the evaluation of a user's response to originally retrieved questions is made against the answers present in the Q&A source used for querying.

In an implementation, answers to originally retrieved questions (or filtered questions) are obtained and presented along with the original questions. In an example, answers to retrieved questions are obtained from the Q&A source used for querying. In a further implementation, the answer to an original retrieved question is the highest rated answer i.e. an answer which is considered most popular or highly rated by users of the Q&A repository used for querying.

In another implementation, apart from extracting keyphrases from an input electronic text document, keyphrases may be obtained from a user. An online Q&A repository is then queried based on keyphrases obtained from an input document as well as a user. In a further implementation, the original seed set (of keyphrases) can be extended using known set expansion techniques or by fetching additional key terms from corresponding Wikipedia pages.

In an implementation, keyphrases are extracted from an input electronic text document and presented to a user. The user can add, modify, and/or remove keyphrases. The user may also provide a weight to each extracted keyphrase. The extracted keyphrases are then used to query a Q&A repository for retrieving relevant questions.

In another implementation, questions retrieved by a Q&A repository are presented based on sequence of topics in the input text document. For example, for a history document, retrieved questions may be presented in a chronological order. In another example, for a procedural document, questions may be arranged and presented based on the steps defined in the procedure.

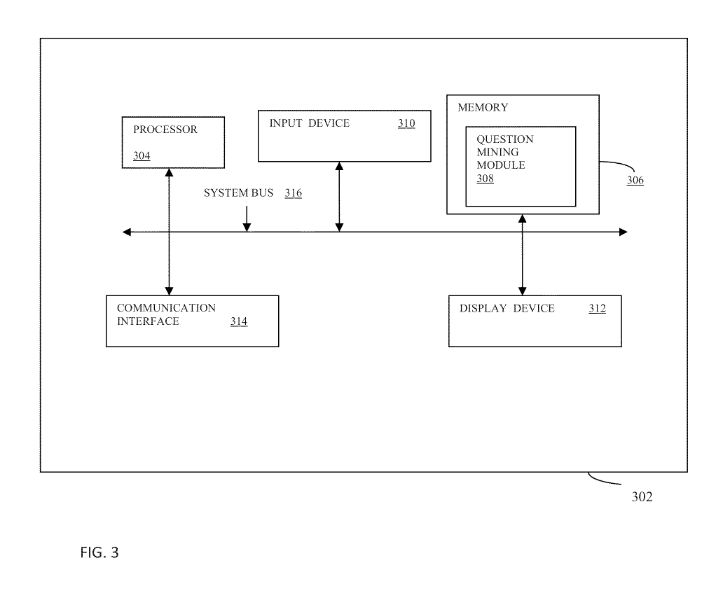

FIG. 3 shows a block diagram of a question mining module hosted at a computer system 302, according to an example.

Computer system 302 may be a computer server, desktop computer, notebook computer, tablet computer, mobile phone, personal digital assistant (PDA), or the like.

Computer system 302 may include processor 304, memory 306, question mining module 308, input device 310, display device 312, and a communication interface 314. The components of the computing system 302 may be coupled together through a system bus 316.

Processor 304 may include any type of processor, microprocessor, or processing logic that interprets and executes instructions.

Memory 306 may include a random access memory (RAM) or another type of dynamic storage device that may store information and instructions non-transitorily for execution by processor 304. For example, memory 306 can be SDRAM (Synchronous DRAM), DDR (Double Data Rate SDRAM), Rambus DRAM (RDRAM), Rambus RAM, etc. or storage memory media, such as, a floppy disk, a hard disk, a CD-ROM, a DVD, a pen drive, etc. Memory 306 may include instructions that when executed by processor 304 implement question mining module 308.

Question mining module 308, in an implementation, extracts keyphrases from an input electronic text document, queries an online question and answer repository based on the keyphrases, retrieves questions related to the keyphrases from the online question and answer repository, and displays the retrieved questions. In other implementations, question mining module 308 may perform other aspects of the method of mining questions related to an electronic text document, as described earlier in this document in reference to FIG. 1. In other implementations, question mining module may be deployed as a desktop application, cloud application, browser plug-in, widget, set of callable APIs (Application Programming Interface), and the like.

Question mining module 308 may be implemented in the form of a computer program product including computer-executable instructions, such as program code, which may be run on any suitable computing environment in conjunction with a suitable operating system, such as Microsoft Windows, Linux or UNIX operating system. Embodiments within the scope of the present solution may also include program products comprising computer-readable media for carrying or having computer-executable instructions or data structures stored thereon. Such computer-readable media can be any available media that can be accessed by a general purpose or special purpose computer. By way of example, such computer-readable media can comprise RAM, ROM, EPROM, EEPROM, CD-ROM, magnetic disk storage or other storage devices, or any other medium which can be used to carry or store desired program code in the form of computer-executable instructions and which can be accessed by a general purpose or special purpose computer.

In an implementation, question mining module 308 may be read into memory 306 from another computer-readable medium, such as data storage device, or from another device via communication interface 316.

Input device 310 may include a keyboard, a mouse, a touch-screen, or other input device. Display device 312 may include a liquid crystal display (LCD), a light-emitting diode (LED) display, a plasma display panel, a television, a computer monitor, and the like.

Communication interface 314 may include any transceiver-like mechanism that enables computing device 302 to communicate with other devices and/or systems via a communication link. Communication interface 314 may be a software program, a hard ware, a firmware, or any combination thereof. Communication interface 314 may provide communication through the use of either or both physical and wireless communication links. To provide a few non-limiting examples, communication interface 314 may be an Ethernet card, a modem, an integrated services digital network (“ISDN”) card, etc.

It would be appreciated that the system components depicted in FIG. 3 are for the purpose of illustration only and the actual components may vary depending on the computing system and architecture deployed for implementation of the present solution. The various components described above may be hosted on a single computing system or multiple computer systems, including servers, connected together through suitable means.

It would be appreciated that the system components depicted in FIG. 3 are for the purpose of illustration only and the actual components may vary depending on the computing system and architecture deployed for implementation of the present solution. The various components described above may be hosted on a single computing system or multiple computer systems, including servers, connected together through suitable means.

For the sake of clarity, the term “module”, as used in this document, may mean to include a software component, a hardware component or a combination thereof. A module may include, by way of example, components, such as software components, processes, tasks, co-routines, functions, attributes, procedures, drivers, firmware, data, databases, data structures, Application Specific Integrated Circuits (ASIC) and other computing devices. The module may reside on a volatile or non-volatile storage medium and configured to interact with a processor of a computer system.

It will be appreciated that the embodiments within the scope of the present solution may be implemented in the form of a computer program product including computer-executable instructions, such as program code, which may be run on any suitable computing environment in conjunction with a suitable operating system, such as Microsoft Windows, Linux or UNIX operating system. Embodiments within the scope of the present solution may also include program products comprising computer-readable media for carrying or having computer-executable instructions or data structures stored thereon. Such computer-readable media can be any available media that can be accessed by a general purpose or special purpose computer. By way of example, such computer-readable media can comprise RAM, ROM, EPROM, EEPROM, CD-ROM, magnetic disk storage or other storage devices, or any other medium which can be used to carry or store desired program code in the form of computer-executable instructions and which can be accessed by a general purpose or special purpose computer.

It should be noted that the above-described embodiment of the present solution is for the purpose of illustration only. Although the solution has been described in conjunction with a specific embodiment thereof, numerous modifications are possible without materially departing from the teachings and advantages of the subject matter described herein. Other substitutions, modifications and changes may be made without departing from the spirit of the present solution.

We claim:

1. A method of mining questions related to an electronic text document, comprising:
extracting keyphrases from an input electronic text document;
querying an online question and answer repository based on the keyphrases;
retrieving questions related to the keyphrases from the online question and answer repository; and
displaying the retrieved questions.

2. The method of claim 1, further comprising filtering the retrieved questions based on a criterion.

3. The method of claim 1, wherein the criterion is grammar of the retrieved questions.

4. The method of claim 1, wherein the criterion is user or system defined.

5. The method of claim 1, wherein the criterion is a profile of a user.

6. The method of claim 1, further comprising displaying another set of questions based on a user's response to the retrieved questions.

7. The method of claim 1, further comprising obtaining additional keyphrases from a user prior to querying the online question and answer repository.

8. The method of claim 1, further comprising modifying the extracted keyphrases prior to querying the online question and answer repository.

9. The method of claim 1, further comprising expanding the extracted keyphrases by applying a set expansion technique.

10. The method of claim 1, further comprising applying weights to the extracted keyphrases based on a user input and querying the online question and answer repository based on the weights applied to the keyphrases.

11. The method of claim 1, further comprising displaying the retrieved questions corresponding to sequence of topics in the input electronic text document

12. The method of claim 1, wherein a different set of the retrieved questions are displayed each time a user accesses the input electronic text document.

13. The method of claim 1, further comprising retrieving and displaying answers to the retrieved questions.

14. The method of claim 1, further comprising displaying a highest rated answer corresponding to each retrieved question.

15. A non-transitory computer readable medium, the non-transitory computer readable medium comprising machine executable instructions, the machine executable instructions when executed by a computer system causes the computer system to:
extract keyphrases from an input electronic text document;
query an online question and answer repository based on the keyphrases;
retrieve questions related to the keyphrases from the online question and answer repository; and
display the retrieved questions.
